(19) United States
(12) Patent Application Publication
(10) Pub. No.: US 2009/0326990 A1
(43) Pub. Date: Dec. 31, 2009

(54) METHOD FOR MANAGING CUSTOMER-BASED AVAILABILITY FOR A TRANSPORTATION CARRIER

(76) Inventors: Roger J. Ashby, Edina, MN (US); Michael J. Lawrence, Eden Prairie, MN (US); Robert T. Wilson, Minneapolis, MN (US)

Correspondence Address: UNISYS CORPORATION, Unisys Way, Mail Station E8-114, Blue Bell, PA, 19424, US

(21) Appl. No.: 12/430,983

(22) Filed: Apr. 28, 2009

Related U.S. Application Data
(62) Division of application No. 11/313,138, filed on Dec. 20, 2005.

(51) Int. Cl. G06Q 10/00; G06Q 30/00; G06Q 50/00

(52) U.S. Cl. 705/5

(57) ABSTRACT

A customer-based availability method for a service provider such as a transportation carrier is disclosed. This method provides programmable logic to allow predetermined request types and service types to be defined. Associations are then formed between request types and service types. When a request is received from a potential customer to book a service, it is automatically determined whether the request is included within one of the request types. If so, it is automatically determined whether that request type is associated with a service type that includes the requested service. If this is the case, the request is allowed to book the service regardless of whether the service is considered to be unavailable, or the sale of the service is otherwise restricted.

### RELATED APPLICATIONS

This patent application is a Divisional of Ser. No. 1/11/313,138 (attorney docket no. RA 5777) entitled “System and Method for Managing Customer-Based Availability for a Transportation Carrier” which was filed on Dec. 20, 2005. The following commonly-assigned Patent Applications have some subject matter in common with the current Application, all of which were filed on even date herewith:

Ser. No. “11/312,302” entitled “Demand Tracking System and Method for a Transportation Carrier”, attorney docket number RA-5773;

Ser. No. “11/312,301” entitled “Rules-Driven Status and Notification System for a Transportation Carrier”, attorney docket number RA-5774;

Ser. No. “11/313,067” entitled “Allocation Limits System and Method for a Transportation Carrier”, attorney docket number RA-5775; and

Ser. No. “11/313,105” entitled “Market-Level Inventory Control System and Method”, attorney docket number RA-5776.

### FIELD OF THE INVENTION

The present invention relates generally to a reservation and departure control system for a transportation carrier; and, more specifically, to a system and method for programmably allowing selected transportation services to be sold to selected customers and/or request types without regard to availability of those services.

### BACKGROUND OF THE INVENTION

Transportation carriers such as airlines, trains, cruise lines, bus companies and the like generally employ some type of reservation and departure control system (RDCS). Such systems are used to book passengers, track baggage, and manage departures and arrivals.

Prior art RDCS systems maintain information on the availability of services on a service-by-service basis. When a request is received to book one of the services, the request can only be fulfilled if the requested service is indicated as being available based on this maintained information. As an example, an RDCS employed by an airline tracks the amount of space that remains available on its flights on a flight-by-flight basis. When a potential customer submits a request to the airline to purchase one or more seats on a particular flight, this request is only fulfilled if the space data being tracked by the RDCS indicates seats are available to fulfill the request.

Some RDCS systems may include limitation mechanisms that allow limits to be placed on the sale of seats for a given route based on booking class. Such limits further restrict access to certain services. As an example, an airline may allow limits to be placed on the number of seats that are being sold in a “Q” booking class. Such a class may, for instance, represent a promotional block of seats being sold at a large discount. When a small predetermined number of such seats have been sold in this booking class as determined by this limit, sales of the seats in this class are automatically discontinued.

The prior art systems described above are relatively inflexible. For instance, when a request for a service is received, if the requested service is considered unavailable or is otherwise associated with a booking class limit, there is no automated mechanism for overriding this determination and allowing the request to be fulfilled regardless of these space and limits considerations. Any such override process can only be performed manually, as by a booking agent at an airport gate, for instance. This leads to inefficiency and fosters customer dissatisfaction.

What is needed, therefore, is an automated mechanism for managing the services of a service provider such as a transportation carrier in a manner that is not necessarily based upon availability information pertaining to the service, or upon previously imposed sales and revenue restrictions for the service.

### SUMMARY OF THE INVENTION

The current invention provides a customer-based availability system and method that allows predetermined customers and/or request types to gain access to predetermined types of services such as flights that are provided by a transportation carrier. The predetermined customer and/or request types are allowed to gain access to these services regardless of whether these services are considered to be unavailable. The current system and method further overrides revenue limits and other types of sales restrictions that would otherwise limit the sale of these services.

As an example of the foregoing, assume that in the case of an airline, all first-class seats have already been booked on all flights from New York City to Hong Kong during November 23-30 of the current year. Therefore, if a typical request is received for a first-class seat on one of these flights, a response will be returned to the potential customer indicating that the request cannot be honored. However, in certain situations, it may be desirable for the airline to disregard the unavailability of the seats so as to allow selected types of requests to be honored. For instance, the airline may wish to fulfill all requests for one of these seats if the requests are received from customers that are considered to be of high value to the carrier. This may be desirable, for example, to foster customer loyalty among those patrons that are considered to be most lucrative for the carrier.

According to the above-described system and method, programmable logic is provided that supports the definition of one or more request types based on customer and/or request data. One or more service (or “inventory”) types are likewise defined. For instance, a service type may describe a group of flights provided by an airline. Finally, one or more request types are matched to one or more service types such that if one of these request types is received, the request is allowed to gain access to the one or more matching services regardless of the availability of these services, and regardless of whether revenue limits have been imposed on the services.

As noted above, the current invention provides programmable logic to define the types of requests and services that will be associated with one another. In one embodiment, this programmable logic includes a rules engine for interpreting programmable business rules. In another embodiment, the programmable logic is table-driven. In either event, the programmable logic may take into consideration any of the types of data retained by the airline.

In one embodiment, request types are defined in reference to customer profile data that is maintained by the airline. Such data may indicate whether a customer is a frequent flier, the amount of money spent by the customer over a predetermined period of time, whether the customer is considered a business traveler or a recreational traveler, whether the customer is affiliated with any particular business, and so on. Any one or more data items of this type may be referenced when defining a customer type. Such data items may be related using Boolean logic.

Similarly, data describing a submitted booking request may likewise be considered in the foregoing manner. For instance, the origin of the request (also called “point-of-sale”, or “POS”) may be referenced when defining a request type. Such POS data may include a particular web site or travel agency from which the request was submitted. It may instead, or additionally, involve the geographic location (e.g., South America) from which the request was issued. If may further include the time and/or date of the request submission. Any combination of data describing the request and/or customer may be employed in this manner to define a request type.

Likewise, any data describing services offered by the carrier may be used to define a service type. As an example, one or more departure locations, times, and/or dates may be used to define a category of flights. Similarly, one or more destination locates may be employed in this manner. Aircraft types, compartments, and booking classes may be used for this purpose. For instance, all seats in the business-class compartments of all flights leaving JFK or Dulles International airports on July 26 destined for Europe may be defined as a service type.

In one embodiment, the matching of request types to service types is accomplished through the use of customer-based availability (CBA) rules. Any of the one or more predetermined request types can be matched to one or more predetermined service types via CBA rules that are interpreted by a rules engine.

According to one aspect, the current invention further supports the use of programmable revenue limits that limit the sale of a certain type of services. For instance, a limit may be placed on the number of discount seats that are available within the Q booking class of the aircraft. This limit may be overridden by a qualifying request type that is matched to this service via a CBA rule. Thus, the customer-based availability rules may be used to override sales limits, if desired.

According to one aspect of the invention, an automated method of managing services provided by a transportation carrier is disclosed. The method includes defining a request type, defining a sub-set of the services, receiving a request for one of the services, and determining whether the request is of the request type. If so, and if the one of the services is included in the sub-set of the services, the one of the services is booked for the request without regard to availability of the service.

In another embodiment, a computer readable medium for causing a device to execute a method for managing services provided by a service provider is described. The method includes maintaining availability data indicating whether one or more of the services are available. The method also comprises receiving a request for a service, determining whether the request is of a predetermined request type, and determining whether the service is of a predetermined service type that corresponds to the predetermined request type. If the request is of the predetermined request type and the service is of the predetermined service type, the request is booked to receive the service regardless of whether the availability data indicates the service is unavailable.

An automated system for providing services that are available from a transportation carrier is further disclosed. This system includes a storage facility to store availability data indicating availability of each of the services, and further to store request types, each of which describes a type of request received by the transportation carrier. The storage facility also stores service types, each describing a type of service provided by the transportation carrier. Access control logic is communicatively coupled to this storage facility to determine whether a request that is received by the system to request a service is of one of the predefined request types. If so, the access control logic is adapted to associate the one of the request types with one of the service types, and to allow the request to be fulfilled irrespective of the availability data if the requested service is of the associated service type.

Yet another embodiment of the invention relates to a computer-implemented system for managing sales of services for a service provider. The system comprises means for receiving a request for a service, and availability means for determining whether the service is available to be booked to the request. The system also includes access control means for determining whether the request is of a selected request type, and if so, for determining whether the requested service is of a service type associated with the selected request type. If so, the access control means books the request to receive the service regardless of any determination made by the availability means.

Other scopes and aspects of the current system and method will become apparent to those skilled in the art from the following description and the accompanying drawings.

### BRIEF DESCRIPTION OF THE DRAWINGS

FIG. 1 is a block diagram of one embodiment of a Reservation and Departure Control System that may usefully employ the current invention.

FIG. 2 is a block diagram illustrating an exemplary embodiment of the Reservation and Departure Control System of FIG. 1 in further detail.

FIG. 3 is a block diagram of one embodiment of a system and method that employs programmable sales limits to handle availability and booking requests within a system such as shown in FIG. 2.

FIG. 4 is a block diagram of one exemplary embodiment of access-control logic according to the current invention.

FIG. 5 is a flow diagram of one method of defining customer-based availability functions according to the current invention.

FIGS. 6A and 6B, when arranged as shown in FIG. 6, are a flow diagram illustrating a method of booking requests using customer-based availability mechanisms according to one embodiment of the current invention.

FIG. 7 is a screen diagram illustrating an exemplary screen such as may be used to define programmable customer-availability and other related rules in a system that employs a graphical user interface (GUI).

### DETAILED DESCRIPTION OF THE DRAWINGS

The system and method of the current invention provides a mechanism for defining programmable rules that match predetermined customers to predetermined services, even though the sale of those services may be otherwise restricted based on limits placed on those services by the carrier. The rules may take into account any of the information provided with the original request to purchase the services, or any booking data used to book the service in response to this request. The rules may also be based on customer profile data such as frequent-flier or customer-value status. This automated system and method adds flexibility to the sales process. The invention further encourages high-value customers such as those that have spent a predetermined amount of money with the carrier to remain loyal to that carrier.

For ease of reference, the following discussion is described primarily in relation to the airlines industry. However, it will be understood that this is merely for exemplary purposes. The system and method described herein may be adapted for use with any transportation provider, such as a bus company, a cruise line, a train service, and so on. Further, this system and method may be adapted for use within other similar services industries, such as the hotel and resort industry.

Before the current invention is described in detail, an overview of an exemplary Reservation Departure and Control System (RDCS) of the type that may employ the current invention is provided for background purposes. It will be understood that any other type of RDCS system may usefully employ the current invention. Moreover, as noted above, the current invention may be adapted for use within a services industry such as a hotel or resort business that does not utilize an RDCS. Thus, the background information is only illustrative in nature, and is not to be considered limiting.

### Reservation Departure and Control System Overview

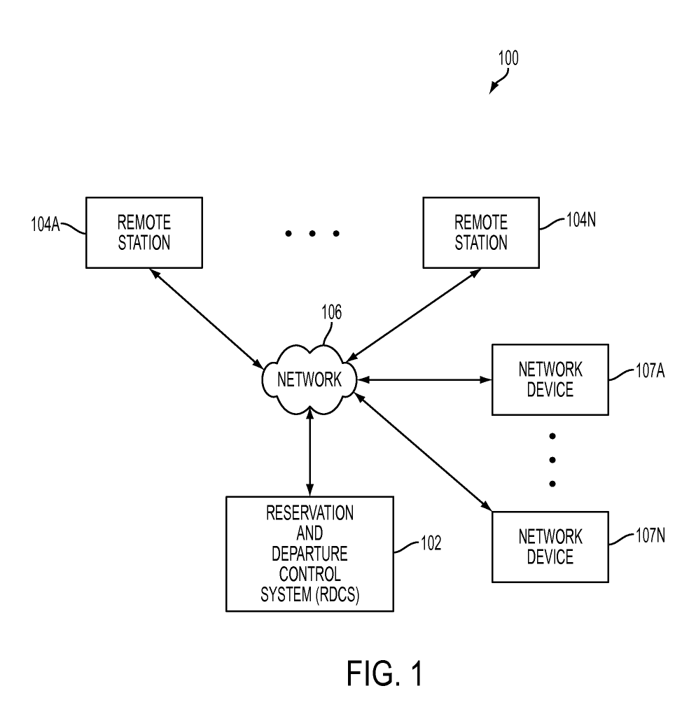

FIG. 1 is a block diagram illustrating an exemplary computing environment 100 that supports a RDCS 102 that may usefully employ the current invention. RDCS 102 provides management and control services to a transportation carrier such as an airline. The services provided by RDCS may include, but are not limited to, request-handling capabilities, booking services, check-in functions, baggage-handling capabilities, and re-booking functions. According to the current invention, RDCS allows programmable logic to be used to match certain customers to services provided by the airline, even though the sale of such services has been restricted. This will be discussed below in a detailed discussion of the invention.

RDCS 100 may be coupled to a network 106. Network 106 may be any private or public network such as the Internet or an intranet, and may include one or more Local Area Networks (LANs), Wide Area Network (WANs), wireless LANs and/or the like. Network 106 may also include one or more connected network-enabled computing and data-processing devices, such as personal computers, laptop computers, handheld computers, workstations, servers, routers, switches, printers, fax machines, telephones, or other devices. For ease of reference, these are represented by network devices 107A-107N. Such network devices execute communication software such as web browsers to communicate with RDCS 102.

Customers may utilize network devices to make requests for services to RDCS 102. For instance, a travel agent or a customer may utilize a personal computer to sign onto a web site that supports the electronic purchase of airline services. This user may then request information describing the availability of flights between a selected origin and destination occurring at one or more times. Once this information is returned, the user may book one or more seats on an available flight. This will be discussed further below.

Also coupled to network 106 are remote stations 104A-104N that allow an authorized person to access RDCS using suitable communication software such as a web browser. Authorized personnel may include, for example, front-line staff, a system administrator, an inventory control agent, or other authorized users employed by the airline. Exemplary tasks include retrieving basic customer data, booking passengers on a flight, performing check-in activities, determining whether additional flights should be added to service a route to match demand, and generally accessing airline data and/or functionality supported by RDCS 102. Although remote stations 104 are typically remotely located from RDCS 102, it will be understood that this need not be the case.

In an illustrated embodiment, RDCS 104 is capable of placing automatic limits on the sale of services in a manner described in commonly-assigned co-pending application entitled “Allocation System and Method for a Transportation Carrier” referenced above, and incorporated herein by reference in its entirety. These limits may be placed on services provided by one or more flights. Authorized agents have the ability to select the factors that will be used to establish the limits. This allows agents to very closely monitor and control the way services are sold, as will be discussed below.

While it is often beneficial to place limits on the sale of services in the manner described above, it may also be desirable to override these limits in certain circumstances. For example, it may be beneficial to allow frequent flier customers, or other customers that are considered to be of high value to the carrier, to be booked on flights even if those flights have been closed to other customers. The current system and method allows this type of override operation to be controlled by programmable rules that match certain customers to services irrespective of the revenue limits that have been imposed by the airline on those services. This will be discussed further below in reference to the detailed description of the invention.

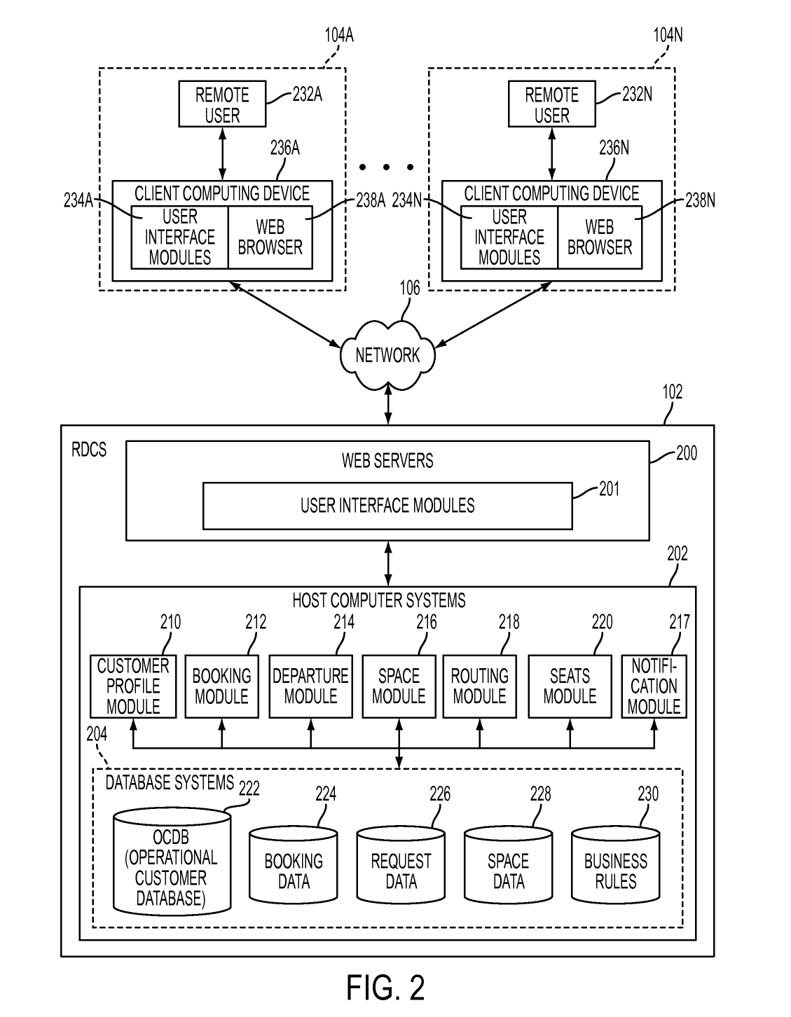

FIG. 2 is a block diagram illustrating an exemplary embodiment of RDCS 102 in further detail. In the exemplary embodiment, RDCS 102 includes one or more web servers 200 coupled to host computer systems 202. Host computer systems 202 may include one or more servers executing the Unix, Linux, Windows®, or any other operating system. Host computer systems 202 provide database systems 204 for storing data. Example database systems include SQL Server™ from Microsoft Corporation and the Oracle™ database from Oracle Corporation. Although illustrated separately, web servers 200 and host computer systems 202 may be integrated, and/or provided by one or more computing systems.

In general, RDCS 102 provides a computing platform for hosting management services for one or more airline carriers. In one embodiment, RDCS 102 provides network-based management of customer data stored in Operational Customer Database (OCDB) 222. OCDB 222 provides a centralized repository for maintaining consistent, current customer data for use by any of the service modules executed by host computer systems.

Host computer systems 202 execute software service modules 210-220. These service modules generally represent software modules having executable instructions to assist airline personnel in providing airline services. In this example, host computer systems 202 execute a customer profile module 210, a booking module 212, a departure module 214, a space module 216, a routing module 218, a seats module 220 and a notification module 217.

Customer profile module 210 allows a remote user to create, retrieve, and update OCDB 222. OCDB 222 is accessible by each of modules 210-220 and stores all information about a customer including preferences regarding seat assignments, meals, preferred connection points, hotel and vehicle preferences, and so on. OCDB 222 may also store contact information, travel plans, special customer needs and requirements, history information including any disservice the customer may have experienced in the past in regards to the carrier, and any resulting compensation. The customer data may also include frequent flier information, an assigned customer value that is based on expenditures with the carrier (e.g., “high-value”), a customer type (e.g., business versus leisure traveler) and other information. In addition, OCDB 222 includes primary or basic customer data such as name, address, and payment information.

Customer profile module 210 may also populate OCDB 222 with links to biometric information maintained in an external database. In some embodiments, OCDB 222 may be embodied by, or coupled to, a Customer Loyalty System (CLS) commercially available from Unisys Corporation that handles processing of frequent flier information.

Turning next to booking module 212, this module receives and manages the booking data associated with airline flights. Booking data is defined as all of the information about a passenger or a group of passengers that are traveling together on the same journey. Such information, sometimes referred to simply as “a booking”, includes passenger names, the one or more flights that are included within the journey, and any special requirements such as special meals, wheelchairs, etc. that may be needed by one or more of the members in the party. It may further include car rental and hotel information, the manner in which the passengers are being ticketed, data regarding travel documents, contact and payment information, and information regarding any other accommodation or service associated with the journey. This data is stored as booking data 224 within database systems 204.

Departure module 214 manages the check-in process on the day of departure, including the check-in of passengers and baggage. For example, an airline employee, shown as one of remote users 232A-232N, may interact with departure module 214 to obtain the issuance of boarding passes and bag tags, and to manage standby passengers. In addition, a remote user may indicate any special needs and requests required by passengers as identified during the check-in process.

Space module 216 manages information regarding the space that is available on flights provided by the current carrier. For instance, this module controls sales restrictions for flights. This module may be coupled to an external space module (not shown), which provides information on space available on flights provided by other carriers. Another related module, seats module 220, provides information on the layout of each aircraft, including information concerning the seating configurations.

A flight module (not shown in FIG. 2) may be provided to define the flights that are hosted by the airline. For example, this module may determine the times and dates that flights will be provided from the various airports serviced by the airline. This flight module stores departure and arrival flight times and locations, the aircraft assigned to a given flight segment, information on fare classes, and information regarding the class of services provided by a flight. This information may include data describing flights provided by the selected airline carrier, as well as flights provided by airline carriers that are considered partners of the selected carrier according to various partnership agreements between two different carriers.

The data created and managed by flight module is available to routing module 218. Routing module 218 utilizes this data to determine the various route options that are available to customers. For example, routing module will determine the best way for a customer to travel from a desired departure location to a destination point using the flights generated by the flight module.

Seats module 220 provides information on the layout of each aircraft, including information concerning the seating configurations. Finally, notification module 217 provides automated notification functions that are programmable based on any of the data stored as booking data 224, request data 226, and/or space data 228. In one embodiment of the current invention, notification module 217 may be programmed to inform an agent at one of remote stations 104 that one or more customers have been matched to a service according to the customer-based availability mechanism of the current invention. This is discussed in detail below.

Host computer systems 202 may include other service modules (not shown) that are coupled to database systems 204, including a ticketing module for managing ticketing activity, an information module for managing automated information such as visa requirements, ticketing rules, luggage policies and procedures, fare rules, promotions and the like, an agreement module to store agreements that exist between an airline and its partners, and a load control module for assisting airline load control agents to plan the distribution of payload aboard an aircraft.

Web servers 200 provide a seamless interface by which remote users 232A-232N or local users (not shown) may access host computer systems 202. Although host computer systems 202 and web servers 200 are illustrated separately in FIG. 2 for exemplary purposes, RDCS 102 may be realized by a single computing device or a plurality of cooperating computing devices such as a clustered computing architecture.

According to the exemplary embodiment of FIG. 2, web servers 200 provide a web-based interface by which authorized remote users 232A-232N communicate with RDCS 102 via network 106. In one configuration, web servers 200 execute web server software, such as software marketed by Microsoft Corporation under the trade designation “INTERNET INFORMATION SERVER.” As such, web servers 200 provide an environment for executing user interface modules 201. User interface modules 201 provide an interface that allows users 232A-232N to manage airline reservations, check-in, and re-booking functions. User interface modules 201 may include Active Server Pages, web pages written in hypertext markup language (HTML) or dynamic HTML, Active X modules, Java scripts, Java Applets, Distributed Component Object Modules (DCOM), and the like.

User interface modules 201 may execute within an operating environment provided by web servers 200. Alternatively, portions of user interface modules 201 may be downloaded as “client-side” user interface modules 234A-234N that are executed on client computing devices 236A-236N, respectively. Client-side user interface modules 234A-234N could, for example, include Active X components or Java scripts executed by web browsers 238A-238N running on client computing devices 236A-236N, respectively.

It will be understood that the RDCS shown in FIG. 2 is exemplary only. Other systems may include fewer or more modules, may omit or add functionality, and/or may implement similar functionality in alternative ways. Thus, FIG. 2 should be considered as only one of many types of systems that may usefully employ the current invention.

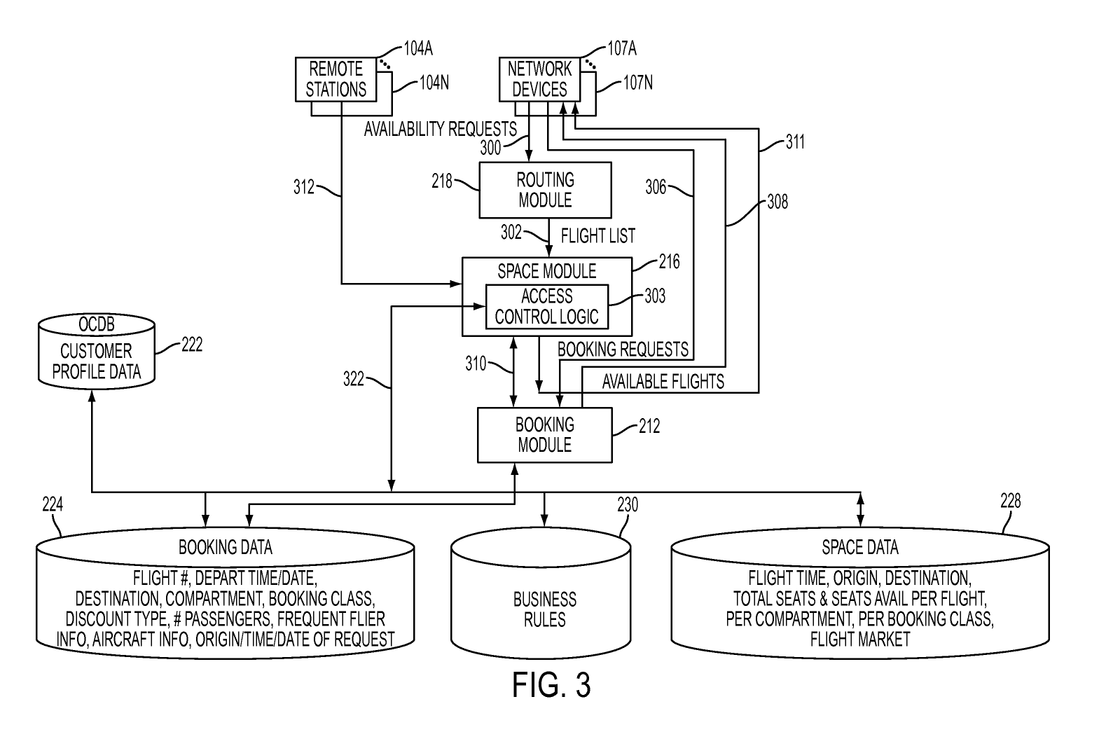

FIG. 3 is a more detailed block diagram of one embodiment of the system and method of FIG. 2. For example, in the system of FIG. 3, availability requests may be received from users of network devices 107A-107N via interface 300. Such requests are submitted to inquire about the availability of one or more flights.

Availability requests may be received from a wide array of sources. For instance, such requests may originate from an on-line travel site such as the Obitz.com web site. These requests may also be submitted via a global distribution system (GDS) of the type used by travel agencies to determine availability of flights. Such GDSs include Saber, Worldspan, Amadeus, and so on. In yet another embodiment, the requests may originate from another RDCS that is hosting a different airline. In one embodiment, availability requests are not only submitted via network devices 107, but are also issued by users at remote stations 104 who may be employed as booking agents by the airline. For ease of reference, only those availability requests submitted by network devices 107 will be discussed, however it will be understood that this discussion applies equally to any availability requests received by RDCS 102, including those submitted via remote stations.

Availability requests generally include such information as a desired departure time, date, and origin, as well as the flight destination location. The requests will generally also specify a desired airplane “compartment”, such as a first-class, business-class, or coach compartment.

Availability requests received from outside of the RDCS 102 (that is, from other than a booking agent located at remote stations 104) will also generally include a flight number. That flight number is obtained from local flight information stored by the entity that issued the request. For instance, a travel agency or an on-line travel web site may locally store information describing the flights provided by one or more airlines. This information may become outdated over time, and thus an availability request may be issued by the travel agency or web site to RDCS 102 to determine whether one or more specified flights are still available.

Availability requests may also include customer information such as a name, a frequent-flier number, and/or other identification data for the customer that is submitting the request. Other information that may be received by RDCS 102 along with the request includes the origin of the request, such as a location (e.g., city, country, continent), and/or the name of the web site from which the request was issued. The type of origin information that is provided with the request will generally vary depending on whether the request was issued via a GDS, the Internet, from a request issued by a booking agent of the airline, and so on.

The request information may also specify whether the request is being issued by schedule or price. In other words, the request will indicate whether the requested departure time is more important than seat price, or vice versa, as determined by information provided by the customer.

As may be appreciated by the foregoing discussion, many different types of information may be provided with an availability request. Such information may include, but is not limited to, the source of the request (e.g., web site, travel agent, etc.), the time and/or date on which the request was issued, the type of request (whether it was issued by price or schedule), the origin and destination of travel, requested time and date of travel, and/or one or more flight numbers (as provided with those requests that originate from sources other than the airline's booking agents, for instance). Other information provided with availability requests may include a compartment name, and customer information (name, frequent flier information, customer identification numbers, etc.).

The availability requests are provided to routing module 218 on line 300. Routing module 218 will select one or more of the existing routes that may potentially satisfy the customer's request. These routes will generally be selected based on the origin and destination of the request, as well as departure time. The most preferential routes will generally be those that contain a single flight that directly services the requested origin and destination locations, and that departs the closest to the requested departure time. Other routes may include multiple flights or flight segments such that a customer traveling on the route may have to change planes and/or experience a delay at an intermediate stopping point. The number of possible options retrieved by routing module 218 for a given request may be a programmable operating parameter of the system that is selected by an authorized airline employee.

After routing module 218 determines a list of routes that may potentially satisfy the customer's request, fare information may be retrieved for these routes. This information may be obtained by making a request to a fare module (not shown), for instance.

Next, this list of flight options, the fare information, and information regarding the availability request are provided by routing module 218 on line 302 to space module 216. Space module then determines which flight and/or flight combinations are considered available, meaning the flights include enough seats of the applicable type to satisfy the availability request. This may involve determining whether available seats reside within the particular compartment specified by the request. The list of available flights that will satisfy the request, and the fares assigned to each of these flights, is returned to the user of network devices 107, as represented by line 311.

The process of submitting an availability request and receiving the results may be repeated any number of times. If the customer finally determines that one of the returned flight or flight combinations will satisfy his/her requirements, a booking request may be submitted to booking module 212, as shown on line 306. This booking request will generally request the purchase of a specified number of seats on a particular flight.

In general, a booking request also includes the price of a seat. This price maps to a booking class and to an aircraft compartment. This booking request will also usually include customer information such as passenger names, any frequent flier information, address, phone, and other customer contact data. The request may further include information such as whether the booking request is associated with any special needs (e.g., a wheel chair request, an unaccompanied minor, and so on.)

When booking module 212 receives the booking request, a determination is made as to whether the requested seats on the requested flight are still available for purchase. In one embodiment, booking module makes this determination by making a request to space module 216 via interface 310. Space module 216 utilizes access-control logic 303 to determine the availability of seats in a manner to be described below. Space module then responds by indicating whether space is available such that the request may be completed.

If space is available, space module ensures that the purchased number of seats is reserved for the given request, although the actual seat assignment will generally not occur at this time. Space module 216 also increments the number of seats sold in the appropriate compartment and booking class of the flight by the purchased number of seats, effectively decrementing the number of available seats for the compartment.

After the seats have been reserved, booking module 212 returns a response to the customer indicating that the booking was completed successfully, as represented by arrow 308. Booking module 212 then stores information describing this booking within booking data 224. The stored information includes data concerning the passengers for this booking, such as passenger names, addresses, any seating preferences or assignments, frequent flier information, payment information, and so on.

As noted above, the foregoing discussion provides one of many exemplary methods for handling booking and availability requests by an RDCS, and is provided for background purposes only. It will be understood that the invention, which is to be described in detail in Section III below, may be used by any RDCS, regardless of whether that RDCS handles booking and availability requests using different modules and/or in a different way than that discussed above.

As discussed above, some RDCS systems control the handling of booking requests by imposing artificial limits on the sales of services. This is discussed in the following Section II for background purposes. An understanding of sales limits (also referred to as “revenue limits”) will be useful when considering the system and method of the current invention, which is described in detail in Section III.

### Background of a System and Method for Setting Revenue Limits

Sales of services may be controlled using artificial revenue limits imposed by the service provider, which for current discussion purposes is an airline. In prior art systems, revenue limits were imposed solely based on booking classes. As is known in the art, booking classes are categorizations used to control availability of seats at predetermined prices. For instance, a promotional deal may be offered whereby a limited number of seats are being sold at a deeply discounted price. To control the number of seats sold at this price, these seats are mapped to a booking class such as class “Q”. The booking class is then generally associated with a compartment (e.g., first class, coach, business, etc.) as well as the predetermined number of seats that will be available at this price.

A limit may be placed on the seats sold within a booking class. For instance, it may be desirable to temporarily halt sales on the seats in Q class when eighty percent of all such seats have been sold. These seats may be re-opened for sale at a later date, for example.

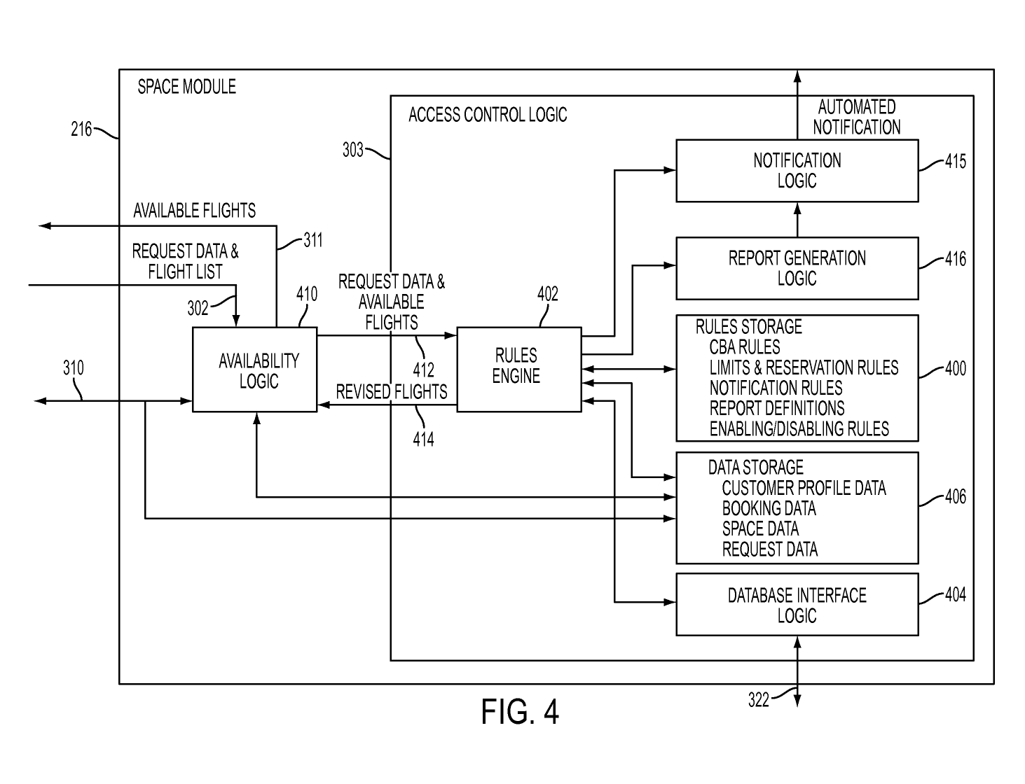

Prior art systems that allow limits to be placed only in reference to booking classes do not provide the necessary flexibility to closely control sales of services. Therefore, an enhanced limits system and method that are considerably more flexible than prior art counterparts are introduced in the co-pending, commonly assigned application entitled “Allocation Limits System and Method for a Transportation Carrier”, referenced above and incorporated herein by reference. An overview of this exemplary system and method is provided in reference to FIG. 4 for background purposes. As noted above, an understanding of this type of limits system and method facilitates a better understanding of the invention, since the current invention may be employed to selectively override revenue limits in a manner that further increase the overall flexibility of RDCS 102. This will be discussed in Section III below.

FIG. 4 is a block diagram of one exemplary embodiment of access-control logic 303 which may be used to impose limits on the sale of services. Access control logic 303 includes rules storage 400, which in this exemplary embodiment stores limits rules. Limits rules are programmable business rules of the type that may be interpreted by a business rules engine of the type known in the art. In the current embodiment, such rules are retrieved from business rules 230 of database systems 204 via interface 322 and retained within rules storage 400 so that they are readily available for processing by access-control logic 303.

Rules storage 400 may be a main or cache memory area that is allocated to access-control logic 303 but physically resides elsewhere, for instance. In another embodiment, it may be storage space that physically resides within space module 216.

Limits rules include rules that automatically restrict the sale of services. That is, even though space may be available within a given compartment of a selected flight, a limit rule may have been defined to indicate that this space is not available to fulfill a particular type of booking request because of attributes associated with the request or the customer submitting the request. For instance, a limits rule may impose a limit on the number of seats that may be sold within the first-class compartments of flights ABC and XYZ for those booking requests issued from the Orbitz.com web site.

Limits rules may take into account any data stored within database systems 204, including booking data 224, space data 228, and/or customer profile data (e.g., information such as whether a customer is a frequent flier or is otherwise considered “high value”.) Such rules may also take into account attributes associated with the request itself such as when, and from where, the request was submitted. Boolean logic operators (e.g., AND, OR, NOT) may be incorporated into the limits and reservation rules.

Rules storage 400 may also store reservation rules that are similar to limits rules, but instead reserve certain services (e.g., seats on flights) for specific customers. As with the limits rules, reservation rules may take into account any booking data 224, space data 228, information associated with a booking request, and/or any customer profile data as may be stored within OCDB 222.

Rules storage 400 is accessible to rules engine 402, which is the logic that is capable of interpreting and executing the various limits, reservation, and other rules as is known in the art. Many business rules engines are commercially available for this purpose. One example is the JRules rules engine commercially available from Ilog Incorporated. In yet another embodiment, rules engine 402 may be replaced by programmable data constructs such as table-driven logic. This is discussed further below.

Rules engine 402 is coupled to database interface logic 404. Database interface logic 322 initiates searching of space data 228, booking data 224, OCDB 222, and any other applicable data stored within databases 204 to retrieve information used to determine whether any limits have been reached. In one embodiment, this type of searching is not needed if all of the data that is required for processing the rules is provided directly by booking module 212 via interface 310 instead of being retrieved by access-control logic 303 from databases 204. For instance, booking module 212 may provide any data associated with a booking request and a subsequently-created booking directly to access-control logic 303 via interface 310 as each booking is being created. If all required data is provided by booking module 212 in this manner, it may be possible to eliminate database interface logic 404.

Assuming data must be retrieved from database systems 204 for use by rules engine 402, that data is returned via interface 322 to database interface logic 404. Database interface logic 404 then stores this data within local data storage 406. Data storage 406 may be storage space in a main memory or a cache memory that has been allocated for use by access-control logic 303. Local data storage 406 may store any combination of customer profile data, booking data, space data, and request data retrieved from database systems 204 or provided via interface 310 directly from booking module 212.

Rules engine 402 is capable of processing the data stored within data storage 406 to determine whether any limits rules have been triggered such that automated limits will be imposed on the sale of services. This can best be understood by again considering how availability and booking requests are processed.

As discussed above, when a potential customer seeks to determine which flights are available to satisfy a desired itinerary, that customer submits an availability request to routing module 218. Routing module generates a list of all potential routes that would, assuming they are available, meet the customer's needs based on departure time and location, and destination location. This list of potential flights is provided along with request information to space module 216 via interface 302 (FIGS. 3 and 4).

When space module 216 receives the list of potential flights from routing module 218, the list is forwarded to availability logic 410. Availability logic utilizes space data 228, which may be cached within data storage 406, to narrow this list to include only those flights that are actually available to satisfy the request. The space data used to make this determination includes information pertaining to total seats available per flight, per compartment in a flight, and per booking class. After availability logic 410 narrows the list of flights in the above-described manner, this narrowed list is then submitted on line 412 to rules engine 402. This list is accompanied by information concerning the availability request that prompted the generation of the flight list. For instance, information concerning the number of seats that are being requested, the origin of the request, time and date of the request, and so on, may be provided along with the flight list on line 412 to rules engine 402.

In response to receipt of the flight list and request information on line 412, rules engine 402 narrows the flight list yet again. This is accomplished by taking into account whether a flight that may seem to be available based on the space data is, in fact, unavailable to satisfy the particular request because of one or more limits or reservation rules that are associated with the flight and/or request type. That is, if employing a flight to satisfy the request would cause some limit or reservation rule to be violated, that flight is eliminated from the original list of available flights generated by rules engine 402. Rules engine 402 provides this revised list of available flights on line 414 to availability logic 410, which forwards it on line 311 as the response to the availability request.

Next, assume the requester issues a booking request to purchase one or more seats on a flight. This booking request is provided to booking module 212 in the above-described manner. Booking module will issue a request on interface 310 to space module 216 to determine whether the requested flight is available. Availability logic 410 must therefore again retrieve the appropriate flight information from space data 228 and/or data storage 406, and rules engine 402 must again verify that no limits or reservation rules are being violated in the manner described above. If space is available and no limits or reservation rules are being violated, a confirmation is issued to booking module 212 to indicate that the seats may be sold and the booking created.

In one embodiment, as the booking is created, booking module provides the booking information on interface 310 to space module 216, thereby allowing space module 216 to update the space data 228 and data within data storage 406 so that it remains current. In particular, space module must record the number of seats that were booked so that these seats are listed as unavailable when a subsequent request is received.

Next, consider the situation wherein rules engine 402 determines that a limit or reservation rule will be violated if a booking request is fulfilled. In this case, the booking request cannot be fulfilled. This information is communicated to availability logic 410, which forwards it to booking module 212, which provides a response to the requester indicating the request was not fulfilled.

One example of the types of limits rules that can artificially limit the sale of space on a flight is as follows:

```
Select (Seats_booked):
    Origin = New York City AND
    Destination = Hong Kong AND
    Depart_date = November 23 - 27 AND
    Compartment = (Coach OR Business_class) AND
    POS = Orbitz OR Expedia
Limit Seats_booked if (Count (Seats_booked) > 50)
```

The first of the foregoing rules defines a service type called “Seats_booked”, which includes those seats on all flights from New York City to Hong Kong departing any time from November 23 through November 27 in the coach or business class compartment, and that are booked from the Orbitz or Expedia web sites points-of-sale (POS).

The second “Limit” rule set forth above indicates that a service of the type “Seats_booked” cannot be booked if fulfilling a request for such a seat will cause the number of such seats booked as returned by the “Count” function to exceed the limit of fifty. If fulfilling the request would cause this limit to be exceeded, rules engine 402 will indicate to availability logic 410 that the booking request cannot be satisfied, as described above.

Those skilled in the art will realize that the above illustration assumes that the data fields “Origin”, “Destination”, “Depart_date”, and so on, have been defined by system designers and are maintained within database systems 204. For example, such fields may be retained within booking data 224 or space data 228. The above example further assumes that data such as “New York City” and “Hong Kong” are valid data values for the corresponding fields.

Many other types of limits rules may be employed in a manner similar to that set forth above. For instance, limits may be set across multiple flights by including departure and destination locations and a range of departure dates, as well as booking dates, as follows:

```
Select (Seats_booked1):
    Origin = New York City AND
    Destination = Hong Kong AND
    Depart_date = November 23 - 27 AND
    Compartment = (Coach OR Business_class) AND
    POS = (Orbitz OR Expedia) AND
    Booking_date = September 1 - 30
```

This rule is similar to that described above, but only applies to booking requests submitted September 1-30. Booking times may also be incorporated into the rules in some embodiments, assuming this type of information is retained in database systems 204.

Many other types of examples may be provided to illustrate limits rules according to the exemplary limits system and method. For instance, if desired, limits may be defined across specific flights, rather than a group of flights that are specified by a market as follows:

```
Select (Seats_booked2):
    Flight_number = (XYZ OR LMN OR ABC) AND
    Booking_class = Q or B AND
    Customer_status = NOT (Frequent_flier OR
                                    Previous_disservice)
Limit Seats_booked2 if (Count (Seats_booked2) ≧ 10)
```

The first of the foregoing rules describes “Seats_booked2” as seats on any of the three specified flights (i.e., XYZ, LMN, or ABC) in booking class Q or B, but only for those customers who are either not a frequent flier (as indicated by attribute “Frequent_flier”), or who have not experienced some type of problem with the airline in the past (as indicated by attribute “Previous_disservice”).

As was the case in regards to the other examples, this rule assumes that the data fields referenced by the rule have been defined. For instance, this example assumes that a field having the label “Customer_status” has been defined. This type of field may be retained within customer profile data of OCDB 222, for instance.

The second “Limit” rule sets a limit on the type of seats indicated by the rule for “Seats_booked2”, as determined by the pre-defined function “Count (Seats_booked)”. If satisfying a received request would cause more than the limited number of ten seats to be sold, the request cannot be fulfilled. Because the definition of “Seats_booked2” excludes customers who did not previously encounter service issues, or who are not frequent fliers, booking requests submitted by these types of excluded customers may still be honored, and are not subject to the limits rule. This example therefore illustrates the manner in which limits may be set across multiple flights, as well as how customer data may be incorporated into such rules.

The exemplary limits system and method also allows limits to be specified using percentages rather than a number of seats. This is exemplified by the following rule:
Limit Seats_booked2 if (Percentage (Seats_booked2)>90)
   This rule places a limit on the types of seats “Seats_booked2” when more than ninety percent of such seats have been booked, as indicated by the pre-defined function “Percentage”.

If may be noted that a condition that triggers a limit may be different from the type of services that are limited. As an example, consider the following rules:

```
Select (Seats_booked3):
    Origin = New York City AND
    Destination = Hong Kong AND
    Depart_date = November 23 - 27 AND
    Compartment = (Coach OR Business_class)
Select (Seats_booked4):
    Origin = New York City AND
    Destination = Hong Kong AND
    Depart_date = November 23 - 27 AND
    Compartment = (Coach OR Business_class) AND
    POS = Orbitz OR Expedia
```

These two rules may be used to define a limit as follows:
Limit Seats_booked3 if (Count (Seats_booked4)≧50)
   This rule limits seats of the type “Seats_booked3” that are booked in coach or business class on flights from New York to Hong Kong departing on November 23 through 27 when the number of seats on those flights that are sold on either the Orbitz or Expedia web sites (as defined by “Seats_booked4”) is equal to, or greater than, fifty seats. Thus, the condition that triggers the limit may be different from the limit itself.

The rate at which booking requests are being received may also be used to trigger the use of a limit as follows:
Limit Seats_booked3 if (Rate (Seats_booked)≧60)
   This rule assumes that a function “Rate” has been defined to calculate a rate at which requests for seats of type “Seats_booked3” are being received. For instance, the rate may be calculated based on the number of requests received per hour. In the current example, when the rate of receipt of such requests exceeds sixty per unit time, the sale of seats of the corresponding type will be limited.

In another variation of the foregoing, the rate at which availability requests are received on line 300 (FIG. 3) may be calculated. This rate may be used to determine when a limit should be imposed.

The above discussion relates primarily to the limiting of the sale of space. The exemplary RDCS may also be employed to reserve space. This may be accomplished using a “Reserve” rule as follows:
Reserve 10 of Seats_booked3 for (POS=Orbitz OR Expedia)
   This rule reserves ten seats of the type “Seats_booked3”, which are seats in coach or business class on flights from New York to Hong Kong departing on November 23 through 27 for requests that are issued from the Orbitz or Expedia websites.

Rules similar to the foregoing may be used to reserve seats for a particular type of customer. For instance, assume that some customers are assigned an attribute of “High_value” because they are customers that have spent a predetermined amount of money in their lifetime on the current carrier. This type of attribute may be saved along with the customer profile data in OCDB 222, or may instead be saved with the booking data. A rule such as the following may be used to save seats on the flights specified by the rule for “Seats_booked3” for this preferred type of customer:
Reserve 10 of Seats_booked3 for (Customer_status=High_value)
   Virtually any type of customer data may be used in this manner.

Reservation rules are processed in much the same way as limits rules. When a seat is to be booked on one of the flights implicated by a reservation rule, rules engine 402 must determine whether satisfying the request will result in the violation of a reservation rule. For instance, if satisfying a booking request results in selling the last seat of the type defined by rule “Seats_booked3” to a customer that is not “High_value”, and only 9 seats have thus far been booked for high-value customers, the booking request cannot be fulfilled.

Limits and reservation rules may be used to shape an airline's sales model. For instance, assume an airline is targeting family business. This airline may define a reservation rule to reserve seats in a lower-fare booking class for those adults that are traveling with children. Another airline may instead target business travelers, and may therefore create reservation rules to reserve seats for those travelers that are booked using a corporate travel account.

It may be noted that the above reservation rules relate to reserving space on an aircraft. Such rules may likewise be employed to reserve other services or to obtain seat assignments for particular customers. For instance, aisle or exit row seat assignments that provide more room for the passenger may be reserved for particular travelers, such as those designated “high value”, as follows:
Reserve 10 of (Aisle OR Exit_row) for (Customer_status=High_value)
   This rule assumes that aisle and exit-row seats are associated with predetermined attributes “Aisle” and “Exit_row”, respectively.

The exemplary limits and reservation rules discussed above allow any combination of booking data, space data, request data, or customer profile data to be used to set limits on sales, or conversely, to reserve space on flights for certain travelers and/or request types. A more extensive discussion of this limits and reservation system and method may be obtained in the co-pending commonly-assigned patent application entitled “Allocation Limits System and Method for a Transportation Carrier” referenced above.

With the foregoing background information of an exemplary RDCS and a limits system available for discussion purposes, a detailed discussion of the invention follows.

### Customer-Based Availability System and Method

The current invention provides a customer-based availability system and method that allows certain customers to gain access to selected services (e.g., flights and/or other related services) regardless of whether these services are considered unavailable, and without regard to the revenue limits and reservation rules that the airline may have been imposed on those services.

According to the invention, customer-based availability rules (“CBA rules”) are defined that, in some ways, are similar to reservation rules that are described above. Reservation rules reserve services for certain types of requests that may, but need not, be submitted. If such requests are not submitted, seats may remain unsold as the departure time of a flight approaches. If that occurs, the reservation rules may be disabled from use so that the unsold seats become available for other types of subsequently-received requests.

Unlike reservation rules, CBA rules are not reserving seats for later requests that may, or may not, be received. Instead, CBA rules are used to identify a certain type of request based on at least one of data describing the request itself, and/or data describing the customer making the request. Other CBA rules are used to define certain types of services (e.g., space on flights) that are then associated with the customer and/or request type. If a request is received of the identified type, the customer submitting the request is allowed to book a corresponding type of service based on the CBA rules, regardless of whether that service is considered unavailable, or has otherwise been limited or reserved by limit or reservation rules, respectively. Use of CBA rules can best be understood by example.

A first rule may be defined to select a particular type of service (also referred to as a predetermined type of inventory) as follows:

```
Select (Inventory1):
    Origin = (New York City OR Washington D.C.) AND
    Destination = China AND
    Depart_date = November 23 - 27 AND
    Compartment = (First_class)
```

This rule defines the type of service as being travel on space defined as “Inventory1”. This space includes all seats in the first class compartment on all flights departing from New York City or Washington D.C. having a destination of China between the dates November 23 through 27 in the first class compartment. It may be noted that airport codes, continents, states, or any other geographic designation that is tracked by the airlines and selected for use in defining business rules may be used as the flight origin and destination points in addition to, or instead of, the examples listed above.

It may further be noted that the definition for “Inventory1” is not related to specific seat assignments. That is, the selected inventory contains a group of seats that is viewed as a “pool” of space without regard to seat assignments. Actual seat assignments are made some time after the booking of the space occurs in a manner beyond the scope of the current invention.

Next, assume that the following additional rule is defined:

Select (Requests1):
Customer_status=High_value OR Previous_disservice

This rule selects as “Requests1” those requests from customers that are considered “high value” by the airline, or those customers that have previously been inconvenienced (i.e., “disserviced”) in some way. For example, a “high value” customer may be a person that has accumulated at least a certain number of frequent flier miles over a predetermined period of time, or who has spent at least a certain amount of money with the airlines over the past year. Any other definition may be used by the airline, as appropriate. A customer that has been inconvenienced may be someone whose bags have been lost during previous travel with the airline, of who has traveled on a certain number of flights that have not been on time. The airline can set any criteria for this status, which may be retained with other customer profile data in OCDB 222 or somewhere else within database systems 204.

Next, “Inventory1” may be associated with requests of type “Requests1” as follows:
Match Requests1 with Inventory1
   This rule states that if a booking request is received from customers of the type defined in “Requests1” for any space of the type described by “Inventory1” (i.e., any seats included in the first class compartment on one of the specified flights), that request should be honored regardless of whether the space on the requested flight is already full, and regardless of whether some revenue limit or reservation rule that has been defined by the airline would otherwise prevent this booking from being completed. In other words, in one embodiment, this CBA rule will override any limits or reservation rules for space of type “Inventory1”, and will likewise override any availability data for these types of seats. If all such space has already been sold when a request of type “Requests1” is received, the above CBA rule will result in overbooking some of the space, a situation that may have to be addressed later, assuming the expected “no-show” rate on the day of departure is not large enough to address this overbooking situation.

If desired, CBA rules may reference multiple request types and seat types. For instance, consider another seat-type definition as follows:

```
Select (Inventory2):
    Origin = China AND
    Destination = (New York City OR Washington D.C.) AND
    Depart_date = November 23 - 27 AND
    Compartment = (First_class OR Business_class)
```

This defines space on flights departing from China November 23 through 27, and arriving in New York City or Washington D.C. A corresponding type of request may be defined as follows:

```
Select (Requests2):
    POS = (Orbitz OR Expedia) AND
    Booking_date = September 1 - 30
    Payment = Visa
```

This rule defines requests of type “Requests2” as being those submitted from the Orbitz or Expedia website during September 1 through 30, and that paid for their seats using a Visa charge card. This type of request may correspond with a promotion involving the specified points-of-sale and/or charge card.

The above-described definitions can be included in a CBA as follows:

Match (Requests1 OR Requests2) with (Inventory1 OR Inventory2)

This rule can be defined to book customers of the type defined by “Requests1” that are requesting seats of types “Inventory1” or “Inventory2”. Similarly, this rule will result in booking customers that make requests of type “Requests2” for seats of type “Inventory1” or “Inventory2”. This booking will occur regardless of whether the requested space is considered unavailable, and regardless of whether other limits or reservation rules have been imposed on this space.

As another example, still another type of inventory may be defined as follows:

Select (Inventory3):
Percentage_seats_open (First_class) > 10

This rule defines “Inventory3” as being all seats on all flights wherein the percentage of seats open in the first class compartment is greater than ten percent. This rule assumes that the function “Percentage_seats_open” has been predefined to select the flights having the identified amount of open space in the selected compartment. As similar rule is as follows:

Select (Inventory4):
Total_seats_open (Business_class) > 10

This rule defines “Inventory4” as being all seats on all flights wherein more than ten seats remain open in the business class compartment. As was the case above, this rule assumes that the function “Total_seats_open” has been predefined to select the flights having the identified amount of open space in the selected compartment.

If desired, multiple request-type and inventory definitions may be included in a CBA rule interconnected by an “AND” keyword, as follows:

Match (Requests1 AND Requests2) with (Inventory2 AND Inventory3
AND Inventory4)

This rule will only book customers that are of the type defined by “Requests1” that make requests of type “Requests2” for the space of the type defined by “Inventory2” on those flights that have a first class compartment that has more than ten percent of the seats open, and that also have a business class compartment that has more than ten seats open.

Customer-based availability rules may also be defined that list specific flights, if desired. For instance, consider the following:

```
Select (Inventory5):
    Flight = (ABC OR DEF OR GHJ) AND
    Compartment = Business_class AND
    Booking_class = P AND
    Booking_date = November 30
```

The following CBA rule can be used to match requests to this type of space:
Match Requests1 with Inventory5
   This rule matches the specified type of customers to space on the three listed flights of “Inventory5” within booking class P of the business class compartment.

If desired, space can be defined using a type of aircraft, as follows:

```
Select (Inventory6):
    Aircraft = 747
    Compartment = First_class
    Departure_date = October 24 - November 3
```

This type of rule defines space that includes any seats in the first-class compartment on any flights that are serviced by 747 aircraft that depart during the specified date range.

Customer-based availability rules may even be used to match certain customers to certain types of additional services (i.e., perquisites, or “perks”) that are provided in addition to flights. Such services may include the granting of certain seat assignment, meals, magazines, special boarding privileges, access to restricted airline facilities such as special waiting areas, and so on. For instance, a certain group of services may be defined as follows:

Select (Services1):
Gold_travel AND Bonus_miles

The rule defines a special set of services that includes “gold travel”, which may grant travelers access to a restricted lounge area in an airport that is controlled by the airline. This set of services also includes bonus frequent flier miles that will be granted to qualified travelers. This set of services may be matched to requests and/or customer using the following CBA rule:
Provide (Requests1 OR Requests2) with (Services1)
   This special type of CBA is used to provide any customers of type “Requests1” or any requests of type “Requests2” with the services defined by “Services1”, regardless of the type of seats being booked.

Any other type of route and/or service can be defined using any of the information stored within database systems 204. Likewise, any other type of customer and/or request data can be referenced to define a customer and/or request type.

The manner in which CBA requests are handled by the exemplary system of FIGS. 1-3 may be considered by returning to FIG. 4. Recall that in the above description of the system of FIG. 4, access-control logic 303 was described solely in terms of providing limits and reservation capabilities of the type described in the co-pending application entitled “Allocation Limits System and Method for a Transportation Carrier” referenced above. These capabilities can be expanded to include the CBA functions described herein. Alternatively, the CBA functions may be used without any limits and reservations capabilities, if desired.

When CBA functions are provided, CBA rules of the type described above may be stored within rules storage 400. These rules are used to process availability requests as follows. Recall that when an availability request is received, a list of possible flights is provided on line 302 to availability logic 410 from routing module 218. When CBA rules are not in use, availability logic 410 uses data stored within data storage 406 and/or space data 228 to determine which of these flights contains available space to satisfy the request. The list containing only those flights having available space is provided to rules engine on line 412. Rules engine 402 then narrows the list still further based on any limits and reservation rules that disqualify from use some flights that initially appear to be available based solely on the space data, but that are actually unavailable because of request and/or customer attributes. The narrowed flight list is returned by rules engine 402 to availability logic 410, which forwards the information to the requester on interface 311 as a response to the availability request.

When CBA rules are being utilized, the above-described process is modified somewhat to include two-steps. First, the flight list from routing module 218 is received on interface 302. This flight list includes information associated with the request, which may include customer information as well as information about the request itself (e.g., POS, request time and date, etc.) Availability logic 410 forwards this list of flights and the request information on interface 412 to rules engine 402.

When rules engine 402 receives the request and/or customer information on interface 412, rules engine determines whether this data satisfies any of the programmable CBA rules stored within rules storage 400. For instance, assume the request was issued to a booking agent by a customer that has flown on the airline before. The customer was previously inconvenienced, and as a result his status includes the attribute “Previous_disservice” within his customer profile. Therefore, this customer is of the type “Requests1” based on the programmable rule discussed above. Rules engine 402 then determines whether any CBA rule is associated with this type of customer. If so, the services that are matched to this customer type by one or more CBA rules are analyzed. This analysis determines whether any of these services correspond with any of the flights received on interface 412 from availability logic. For example, in the CBA rule discussed above, “Requests1” are matched to “Inventory1”. If the definition for “Inventory1” includes any of the flights provided on interface 412, the seats described by the CBA rule for those flights will be considered available regardless of what the availability data stored within data storage 406 and/or space data 228 may indicate. These are considered the “CBA seats/flights”.

After the CBA rules are analyzed by rules engine 402, the list of CBA seats/flights is returned on interface 414 to availability logic 410. This list will be included in the response to the requester regardless of what the space data indicates, and regardless of whether any of these seats/flights are implicated by any limits or reservation rules. Therefore, this portion of the flight list need not be processes any further.

Next, the list of any other remaining flights that were provided on interface 302 but which were not included in the CBA seats/flights list are processed in the manner described above in relation to the limits rules. Specifically, availability data within data storage 406 and/or space data 228 will be used to determine which of these flights within the list of remaining flights have space available of the type needed to accommodate the request. Any flights without space available to satisfy the request are removed from the list, and the remaining flight list is provided on interface 412 to rules engine 402 along with request information.

Rules engine analyzes any limits or reservation rules associated with each of the available remaining flights to determine whether any additional flights must be eliminated from the list because satisfying the request with space from these flights would result in a rules violation. After this elimination process in complete, any remaining available flights are returned on interface 414. This list of remaining available flights and associated seat information is concatenated with the CBA seats/flights list and returned on interface 311 as the response to the availability request.

As noted above, CBA rules may be employed without the use of limits or reservation rules. In this case, the second step in the above two-step process may be eliminated. That is, rules engine 402 will first generate the CBA seats/flights list. For all remaining flight options that are not on this list, availability logic 410 will eliminate all flights that are not considered available based on availability data stored within data storage 406 and/or space data 228. The available flights are concatenated with the flights in the CBA seats/flights list and returned on interface 311 as the response. In this case, there is no additional step of applying the limits or reservation rules.

The foregoing describes processing that occurs for the availability requests using CBA rules. In a similar manner, booking requests may also be processed using the CBA rules. When a booking request is received on interface 310 from booking module 212, availability logic 410 forwards the request to rules engine 402. Rules engine determines whether the request and/or customer information is associated with one or more CBA rules. If so, the flights and seats associated with these CBA rules are analyzed to determine whether these seats and flights include a seat and flight specified by the booking request. If so, this information is returned by rules engine 402 on interface 414 to availability logic 410 as the CBA seats/flights list.

If a requested flight is included in a CBA definition, that flight need not be processed any further. The booking may be completed regardless of whether space data indicates the requested space is unavailable, or whether limits or reservation rules would otherwise prohibit the booking from being completed. As such, an indication is provided by availability logic 410 via interface 310 to booking module 212 that the booking may be completed.

For any requested flight that is not included in the CBA definition, processing proceeds in the conventional manner discussed above. That is, availability logic 410 must retrieve the appropriate flight information from space data 228 and/or data storage 406 to determine whether the requested space on the specified flight is available. If so, and if limits and/or reservation rules are in use, rules engine verifies that no limits or reservation rules are being violated in the manner described above. If space is available and no limits or reservation rules are being violated, a confirmation is issued to booking module 212 to indicate that the seats may be sold and the booking created for the requested space.

In the above-described embodiments, the CBA rules override limits and reservation rules. In an alternative embodiment, this need not be the case. That is, limits and reservation rules may be defined to take precedence over the CBA rules such that the CBA rules only override the availability data, and the limits and reservation rules, in turn, override the CBA rules. In still another variation of the foregoing, the order of precedence between the various rule types may be defined programmably by a system administrator.

In one embodiment, automated notifications may be generated when a booking is created on space included in a CBA definition. For instance, when rules engine determines that a request type is included in a CBA definition, and the matching service is a requested flight, a pre-defined notification rule may cause rules engine 402 to automatically generate a notification to one or more authorized employees. Such rules, which may be stored in rules storage 400, indicate if, and how, any automated notifications are to be generated. An exemplary notification may send an email message to an authorized employee describing the service that was booked using the CBA rule, for instance. Other types of automatic notifications that may be issued include the generation of an automated telephone message or fax transmission, the issuance of a page, the saving of an electronic document at a predetermined location in a directory structure, the transmission of a document to a predetermined print device, generation of an instant message, and so on. Any of these types of notifications may be defined by a notification rule, which is one of the types of rules retained within rules storage 400.

Several exemplary notification rules are as follows:

Notify1: email message1 address_list1
Notify1 if (Match (Requests1 OR Requests2) with (Inventory1 OR
Inventory2))

The first rule defines a notification action designated as “Notify1”. This notification action will result in notification logic 415 sending an email message containing the text associated with “message1” to all of the personnel associated with the address list “address_list1”. This rule pre-supposes that the message and address list associated with “message1” and “address_list1”, respectively, have been defined.

The second rule, which may be referred to as a trigger event rule, indicates that the notification action associated with the character string “Notify1” will be initiated if the listed CBA rule is invoked. That is, if either a customer of type “Requests1” and/or a request of type “Requests2” are requesting space of the type described by “Inventory1” or “Inventory2” such that a booking occurs, the notification action associated with “Notify1” should be initiated.

In the embodiment shown in FIG. 4, the notification action may be initiated by notification logic 415 that is dedicated to space module 216. In another embodiment, a centralized notification module such as notification module 217 of FIG. 2 may perform the types of automated notification actions described above. In this alternative embodiment, notification module 217 may provide automated notifications for other modules shown in FIG. 2 in addition to generating notifications related to CBA events.

Notifications may involve the automated creation by report generation logic 416 of a pre-defined report, the contents of which are determined by a respective report definition. Report definitions, like the other rules, may be retrieved from business rules 230 and retained within rules storage 400, or may instead be retained permanently by report generation logic 416. A report may include data that is retrieved directly from database systems 204, or that has been cached within one of the local storage areas such as data storage 406. For instance, a report may include information on the booking requests that are booked to a flight included within a CBA rule. A report may comprise information retrieved from booking data 224, space data 228, data associated with the booking request, customer profile data, and/or any other data retained within database systems 204 for use by RDCS 102. If desired, a report may be included as an attachment to an email notification, or may be automatically stored to one or more predetermined locations within RDCS 102.

The current invention further allows an airline or other carrier to selectively enable and/or disable the use of one or more CBA rules. For instance, an enabling rule may be defined as follows:
Enable (Match Requests1 with Inventory1) if (Date>Jan. 1, 2006)
   This rule enables the use of the CBA that matches customers of type “Requests1” with space of the type defined by “Inventory1” after Jan. 1, 2006. Before this time, this CBA rule is not enabled. In one embodiment, the default operation enables the CBA at the time it is defined. The use of enabling rules is a system option that can be selected by a system administrator, for example.

In a similar manner, disabling rules may indicate that one or more CBA rules are to be taken out of use. For example, a disabling rule may disable use of the above-described CBA rule after a particular time and date.

It may be noted that the syntax used to illustrate CBA rules, as well as the other limits, reservation, notification, and enabling/disabling rules is merely intended for discussion purposes and to exemplify concepts. It will be understood that this syntax is largely arbitrary and many syntax variations may be used to express these concepts. Moreover, while the foregoing examples utilize a pseudo English language format for ease of reference, it will be appreciated that when these rules are stored as business rules 230, they are expressed in a digital format (e.g., as a series of ones and zeros) that may be interpreted by the software, firmware, microcode, and/or hardware used to implement access-control logic 303, and specifically, rules engine 402.

A user may define the limits and/or notification rules using a rules language such as that described above, which is similar to a programming or query language. Alternatively, these rules may be defined using the help of a Graphical User Interface (GUI) that is provided as one of user interface modules 234 (FIG. 2) executing on remote stations 104 and/or user interface modules 201 on web servers 200. If this type of interface is used, it may not be necessary for the user to become familiar with a rules language, since the GUI interface will format the rules as the GUI operators (e.g., drop-down menus, radios, buttons, etc.) are selected. An exemplary GUI interface will be discussed further below.

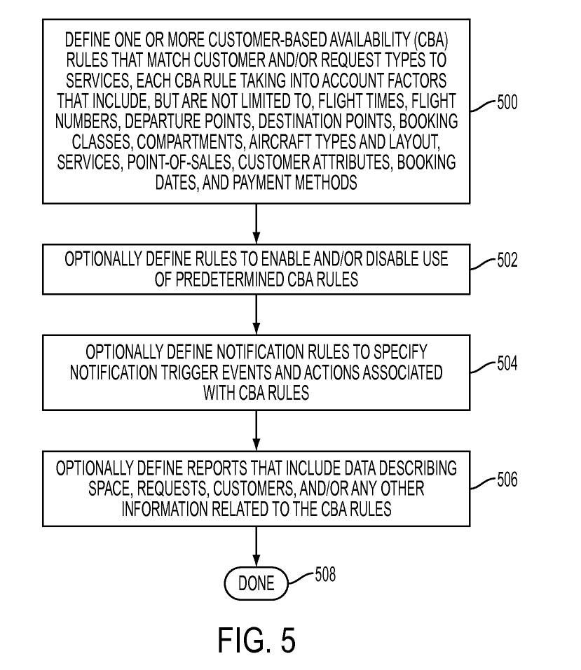

It may be appreciated that the system of FIG. 4 is exemplary only, and many other embodiments of this logic are possible within the scope of the current invention. Similarly, it will be understood that the CBA functionality shown in FIG. 4 may be included in the space module 216, may be included in a dedicated CBA module, or may instead reside within one or more other modules besides space module 216. Inclusion in space module 216 is preferred since this minimizes message traffic. In general, the various logic sections and modules shown in FIG. 5 are implemented in software, firmware, microcode, or some combination thereof that are executing on a server. However, some of these logic sections may alternatively be implemented partially or entirely in hardware in another embodiment. Finally, some of the logic shown in FIG. 4 may be omitted, or may be implemented in another manner. For instance, notification logic 415 and report generation logic 416 are optional. Similarly, if all data is retrieved from databases 204 prior to processing, the local storage represented by data storage 406 may be eliminated.

In one alternative embodiment, rules engine 402 and rules storage 400 may be replaced by tables. For instance, a table may be defined to include all of the attributes that may be used to define a type of space within a flight (e.g., departure and destination locations, flight numbers, departure times and dates, compartments, booking classes, etc.) The table includes an entry for each potential combination of the attributes. This entry lists the “rules” for that attribute combination. For instance, the entry may store data describing if, and how, customer-based availability will be handled for that attribute combination. The logic (e.g., the software) consults the appropriate table entry to determine how processing should proceed. This type of table-driven approach has the advantage of not requiring the use of a specialized rules engine. However, it does not provide the flexibility afforded by a rules engine, which allows new attributes and logic to be added dynamically.

FIG. 5 is a flow diagram of one method of defining customer-based availability functions according to the current invention. One or more customer-based availability rules are defined to match customer and/or request types to services provided by an airline or another transportation carrier (500). Each CBA rule may take into account data that describes space, requests, customers and/or any other data maintained by the carrier. This data may include, but is not limited to, flight times, flight numbers, departure and destination points (e.g., cities, states, airport codes, countries, continents, and/or any other location designation), booking classes, compartments, craft types (e.g., types of aircraft), layout of the craft (e.g., seats arrangements within the aircraft), other services (e.g., special meals, magazines, access to lounge areas), points-of-sale, customer attributes, booking dates, and payment methods.

In addition to the CBA rules, other rules may be defined if desired. For instance, rules may be defined to enable and/or disable use of predetermined corresponding CBA rules (502). Additionally, notification rules may be defined to specify notification trigger events and notification actions that are associated with the CBA rules (504). For instance, a trigger event could include the booking of a request that is included in a CBA rule. The notification action may comprise sending an email message to one or more authorized airline personnel. Report definitions may likewise be defined to include data describing space, requests, customers, and/or any other information maintained by the transportation carrier that relates to the CBA rules (506).

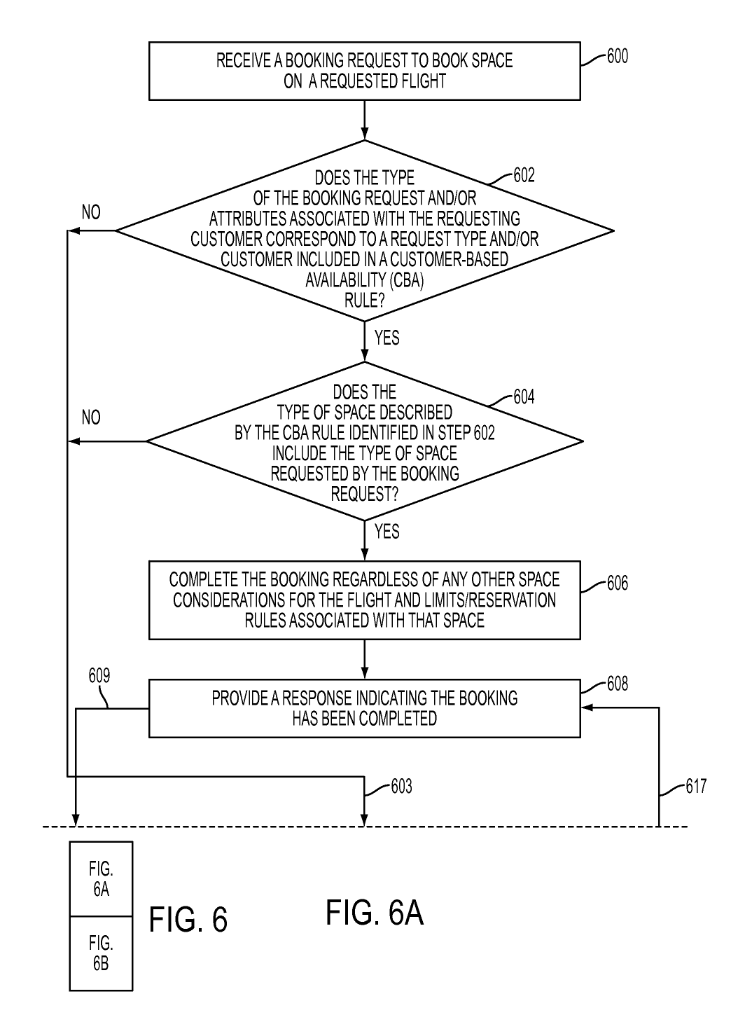

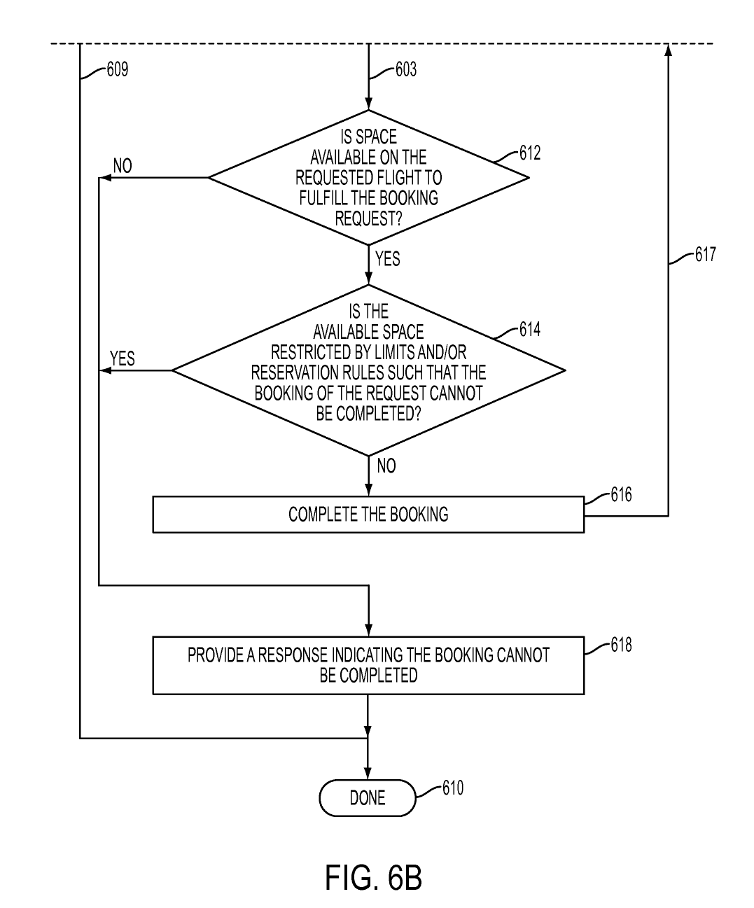

FIGS. 6A and 6B, when arranged as shown in FIG. 6, are a flow diagram illustrating a method of booking requests using customer-based availability mechanisms according to one embodiment of the current invention. First, a booking request is received to book space on a requested flight (600). It is determined whether the type of booking request and/or attributes associated with the requesting customer correspond to a request type and/or customer attributes included in a Customer-Based Availability (CBA) rule (602). If so, it is determined whether the type of space described by that CBA rule includes the type of space that is being requested by the booking request (604). If so, the requested booking may be completed regardless of whether the requested type of space is considered available for the requested flight, and regardless of whether any other limits and/or reservation rules restrict access to the requested space (606). A response is provided indicating the request has been completed (608), and processing continues to FIG. 6B as indicated by arrow 609. There, processing is considered completed (610).

Returning to step 602 of FIG. 6A, if it is determined that the type of booking request and/or requesting customer does not correspond to a CBA rule, or, if in step 604 it is determined that the type of space described by the CBA rule does not include the type of space requested by the booking request, processing continues to step 612 of FIG. 6B, as indicated by arrow 603. There, it is determined whether space of the requested type is available on the requested flight (612). If so, it is determined whether any limits and/or reservation rules restrict this available space such that the booking cannot be completed (614). If no such limits or reservations restrict space, the booking may be completed (616). Processing continues to step 608 of FIG. 6A, as indicated by arrow 617 where a response is returned indicating the booking has been completed. Processing is then considered complete, as indicated by step 610 of FIG. 6B.

If, in step 612 no space is available on the requested flight to fulfill the booking request, or if, in step 614, the available space is restricted by limits and/or reservation rules such that booking request cannot be fulfilled, processing continues to step 618. There, a response is provided indicating the booking cannot be completed. Processing is then concluded (610).

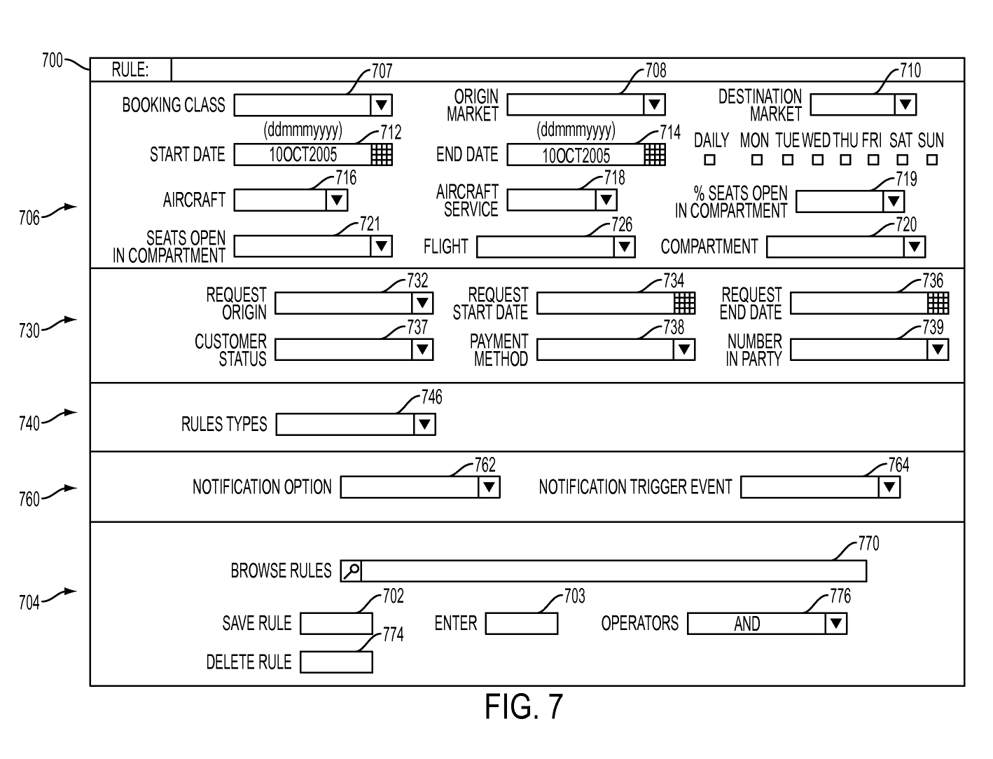

FIG. 7 is a screen diagram illustrating an exemplary screen such as may be used to define programmable customer-availability and other related rules in a system that employs a graphical user interface (GU I). A window 700 is used to display a rule that is under definition by an authorized user such as an authorized airline inventory control agent. When the definition has been completed, it may be saved, if desired, by selecting the “Save Rule” button 702 of screen area 704.

Rules such as those exemplified above are defined by making selections using drop-down menus and other GUI utilities such as radios, buttons, browse functions, and so on. For instance, screen area 706 provides various GUI functions for use in defining the type of space or other services to be included within CBA rules. Using the drop-down menus in screen area 706, these definitions can reference such information as booking classes, which are selected using drop-down menu 707. Drop-down menus 708 and 710 may be provided to allow selection of origin and destination markets, respectively. Options provided by these menus may include cities, airport codes, states, countries, continents, and/or any other geographic designations as determined by the interface designer.

Also included in screen area 706 are start and end date input areas 712 and 714, respectively, which allow date ranges for the flights to be added to a rule. If desired, specific days of the week may be selected to limit these date ranges. Thus, for instance, the search may be defined to consider only those flights departing on one of the selected days of the week within the specified date range.

Other information that may be selected for use in a rule definition includes types of aircraft, compartments, and actual flight numbers. These are selected using menus 716, 720, and 726, respectively. If some CBA rules are to reference services other than the actual booking of space, input area 718 may be used. Such services may include meals, types of magazines, access to special areas such as restricted lounges within an airport, and so on.

In the manner described above, inventory may be defined by selecting space on flights having a certain number of seats that are still available. For instance, drop-down menus 719 and 721 may be used to select a compartment type for use in specifying a selected percentage of seats available per compartment, and a total number of seats available per compartment, respectively. An input area located to the left of these drop-down menus may be provided to select the percentage and total number to be used in this manner, respectively. For instance, the cursor may be located within one of these input areas so that a number may be entered using a keyboard.

Screen area 706 may also be used to define the types of space to be included in CBA rules. To begin this type of definition, a user may enter a rule type using menu 746 of input area 740. This type of rule may be an “inventory definition”, selection of which will cause the “Select” keyword to appear in window 700. Next, the user may enter a label such as “Inventory1” into window 700 using the keyboard or another entry device. Then the various fields to be included in the rule are selected using the menus of screen area 706. In one embodiment, the selections made within a particular screen area such as screen area 706 are, by default, connected by a predetermined Boolean operator such as “AND”. Thus, when the “Enter” key 703 of input area 704 is selected, the various data selections selected by the drop-down menus of screen area 706 will appear within window 700 interconnected by the “AND” Boolean operator.

Multiple data items of the same type may be selected, if desired. For instance, if multiple flights are to be selected within the same rule, a first set of data selections containing a first of the multiple flight numbers is entered into screen area 706 and the Enter button 703 is selected. This causes the initial rule definition to appear in window 700. A different flight number may then be selected using drop-down menu 726, and the desired Boolean operator may be selected (for instance, the “OR” operator) using menu 776. Selection of the Enter button 703 causes the additional flight number to be inserted after the first flight number using the desired Boolean operator (e.g., “OR”). This will be shown in window 700. This process may be repeated any number of times. When this process is completed, the rule may be stored along with a desired label (e.g., “Inventory1”) that was provided by the user via keyboard entry, for instance. Saving of the rule is initiated by selection of the “Save Rule” button 702.

Window 730 includes various GUI functions to allow types of customers and/or requests to be defined. This is accomplished using a method similar to that described above in reference to the defining of types of inventory. The types of data that may be referenced in this case include the request origin for the booking request (i.e., the point-of-sale). A request origin, which may include particular web sites, geographic locations, travel agencies, booking offices of the airlines, and so on, may be selected using drop down menu 732. The date range for submission of the booking request may be specified using areas 734 and 736, respectively. A customer status menu 737 may be provided to define CBA rules that reference certain types of customers. For instance, customers that are considered frequent fliers based on their accumulated miles, or other customers that are considered to be of high value to the airlines, may be referenced by a CBA rule. Also include may be a menu 738 to select method of payment (e.g., Visa, MasterCard, a credit-card affiliated with the airline, etc.) Drop-down menu 739 may be provided to select the number of people in the party. For instance, it may be desirable to define a CBA rule that is applicable if only four or fewer people are in the party. Other types of menu areas may be provided to select types of requests and/or customers.

As noted above, screen area 740 includes a menu 746 to specify rule types. This menu is used to select the CBA rule-type followed by activation of the enter button 703, which will result in a keyword “Match” being displayed in window 700. The browse rule function associated with window 770 of screen area 704 may then be used to browse previously-defined request and inventory types so that one or more designated request types may be matched with one or more inventory types in the manner described above. In a similar manner, a rule type that matches customers to other services may be defined, as discussed above.

Screen area 760 provides drop-down menu 762 to select notification options such as email, fax, pager, printer, and/or other automatically-generated transmissions. The options depicted using this drop down menu may be used to define notification rules. Another drop-down menu 764 is provided to select a notification trigger event to be associated with the notification rule. These trigger events are defined using another screen similar to that shown in FIG. 7.

As discussed above, screen area 704 includes various general-purpose utilities such as the “Save rule” button 702 that is used to save the rule appearing in window 700 when a definition is considered complete. The “Browse rule” window 770 allows a user to browse for previously defined request and/or inventory types so that they can be incorporated into a CBA rule. An authorized user may decide to delete a previously-defined rule highlighted in window 770 using the “Delete rule” button 774. Drop-down menu 776 allows a user to select Boolean operators (e.g., AND, OR, NOT) for inclusion in the rules, as mentioned above.

The exemplary screen of FIG. 7 provides a very simple illustration of one screen of a GUI interface that may be utilized to define CBA and notification rules according to one embodiment of the current invention. It will be appreciated that a suitable interface may have many screens that may be similar to that shown in FIG. 7 for providing all of the necessary input areas. For instance, for ease of reference, this figure does not illustrate a window for report definitions, or for defining the notification options such as the device and path names, email address lists, and so on, that are used to generate the notification. Other similar windows may be defined to support entry of other types of rules. Moreover, many alternative user interfaces may be provided for the current system and method, including an interface that supports rules definition using a rules-definition language such as that illustrated above.

The invention is susceptible to various modifications and alternative forms. Specific embodiments thereof have been shown by way of example only. For instance, many variations of the methods that are described herein are possible. Some of the steps may be deleted, and many of the steps may be re-ordered. These steps may be performed in hardware, software, firmware or any combination thereof.

In addition to the foregoing, it will be noted that while the above discussion relates primarily to a system for selling space using customer-based availability rules for an airline, this is merely for ease of reference. Any other transportation carrier such as a bus company, cruise line, train service, or the like, may usefully employ the current invention. Similarly, other services industries may utilize the system and method to control the sale of services and maximize revenues. For instance, a hotel or resort chain may employ a similar system based on programmable rules to control the sale of rooms based on request and customer information and space data. As another example, a service that specializes in the sale of seats for public events such as sporting engagements, concerts, or other similar activities may utilize the current system and method.

Thus, it should be understood that the detailed description is not intended to limit the invention to the particular forms disclosed. On the contrary, the intention is to cover all modifications, equivalents, and alternatives falling within the spirit and scope of the invention as defined by the appended claims.

What is claimed is:

1. An automated method of managing services provided by a transportation carrier, comprising:
defining a request type;
defining a sub-set of the services;
receiving a request for one of the services; and
determining whether the request is of the defined request type and requesting one of the services included in the defined sub-set of the services, and (i) if it is, booking the one of the services for the request without regard to availability of the one of the services and (ii) if it is not, booking the request as a function of the availability of the one of the services.

2. The method of claim 1, wherein the request type is defined based on at least one of data describing requests and data describing customers submitting the requests.

3. The method of claim 1, wherein the request type is defined based on one or more factors selected from a group consisting of:
an origin of a request;
a time of request submission;
a date of request submission;
number of people associated with a request;
customer information describing one or more customers submitting a request; and
a form of payment for a service requested by a request.

4. The method of claim 1, wherein the sub-set of services is defined based on one or more factors selected from the group consisting of:
a departure location for a transportation route;
a destination location for a transportation route;
a time of departure for a transportation route;
a date of departure for a transportation route;
a booking class for a transportation route;
a compartment for a transportation route;
a type of a craft servicing a transportation route;
a layout of a craft servicing a transportation route; and
a description of perquisites provided by the transportation carrier.

5. The method of claim 1 wherein at least one of the first defining step, the second defining step, and the determining step employs programmable logic selected from a group consisting of:
programmable business rules; and
programmable data constructs.

6. The method of claim 1 further including automatically issuing a communication regarding the booking of the one of the services for the request without regard to availability of the one of the services.

7. The method of claim 1, wherein at least one of the first defining step, the second defining step, and the determining step employs a graphical user interface.
